(19) United States
(12) Patent Application Publication
(10) Pub. No.: US 2010/0058116 A1
(43) Pub. Date: Mar. 4, 2010

(54) SYSTEM FOR PROCESSING GRAPHIC OBJECTS INCLUDING A SECURED GRAPHIC MANAGER

(75) Inventors: Denis Bonnet, Bordeaux (FR); Patrice Capircio, Le Taillan Medoc (FR); Alexandre Fine, Saint Medard En Jalles (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/514,483

(22) PCT Filed: Nov. 13, 2007
(86) PCT No.: PCT/EP2007/062279

§ 371 Date: May 12, 2009

(30) Foreign Application Priority Data
Nov. 17, 2006 (FR) 06/10078

(51) Int. Cl. G06F 3/048; G06F 11/07

(52) U.S. Cl. 714/47; 715/781; 714/E11.024

(57) ABSTRACT

The general field of the invention is that of viewing systems that have to display information or images having different criticality levels. The viewing system according to the invention comprises at least one secure graphic manager with a criticality level at least equal to the highest criticality level of the graphic applications. The manager has the following detection means: violation of the segregation of the applications in their respective display window; overrunning of the processing times of each application; and violation of the specific storage spaces of the graphic applications.

### CROSS-REFERENCE TO RELATED APPLICATIONS

The present Application is based on International Application No. PCT/EP2007/062279, filed on Nov. 13, 2007, which in turn corresponds to French Application No. 0610078, filed on Nov. 17, 2006, and priority is hereby claimed under 35 USC §119 based on these applications. Each of these applications are hereby incorporated by reference in their entirety into the present application.

### BACKGROUND OF THE INVENTION

1. Field of the Invention

The field of the invention is that of viewing systems that have to display information or images having different criticality levels. The preferred field of application is the field of aircraft cockpits, but the invention may apply to any control system having viewing screens on which it must be possible to display simultaneously critical information, that is important for the security of the system, and information of lesser criticality which is not vital for the security of the aircraft, its crew and its passengers.

2. Description of the Prior Art

Usually, a viewing system comprises three main devices as indicated in FIG. 1. A first device 1 called the “computing resource” or else CPU, the acronym for “Computer Processing Unit”, makes it possible to carry out various computations of symbologies based on data originating from the databases and the sensors of the aircraft. In the rest of the text, an “application” will be called each computation of symbologies. A second device 2 connected to the first is called the “graphic resource” or else GPU, the acronym for “Graphics Processing Unit”. It converts the applications originating from the CPU into video signals. The system also comprises a memory shared between said graphic applications, each application having a specific storage space in said memory. The last device 3 is a set of views that may comprise one or more display screens. Usually, for recent applications, these are liquid-crystal matrix screens.

On small-sized screens, only one application is displayed on the screen. With the increase in screen size, several applications may be made to share the screen and therefore to be displayed simultaneously. These applications frequently have different criticality levels. Therefore, in the aviation field, it is possible to have to display simultaneously critical piloting information and to have to present simultaneously a digital map of the ground being overflown, information that is considered to be noncritical because it is not likely to place the safety of the aircraft in danger. It is then necessary, for problems of cost and safety, to allocate different criticality levels to them. High-criticality information receives particular methods of development and implementation providing them with very high reliability whereas low-criticality information has less reliability, but at a less costly development price. Therefore, in the aviation field, critical information has a failure rate of 10⁻⁹ per hour of flight, that is one failure per billion flying hours whereas noncritical information has a failure rate varying from 10⁻⁵ to 10⁻³ per flying hour, that is a possible failure every hundred to ten thousand flying hours.

These applications are processed or may be processed by a common graphic resource. It is then necessary to manage the problems of different criticalities. There are various possible solutions. For example, it is possible to reserve access to the graphic resource for the applications with the highest criticality level. Naturally, there is then no flexibility in the distribution of the images on the graphic resources. A second solution consists in processing all the applications at the highest criticality level. In this case, the development costs become prohibitive because the noncritical applications are developed like critical applications.

Another solution has been proposed by Honeywell and is described in American patent U.S. Pat. No. 6,980,216, the English title of which is “Graphics driver and method with time partitioning”. The principle of this method is to allocate a provisional length of time to each application and to check, when the application is running, whether this length of time is reached or overrun. This solution, which is a significant advance over the previous solutions, nevertheless has certain disadvantages. On the one hand, it proposes only a time segregation of the applications. On the other hand, it requires a detailed knowledge of the graphic chain, because it requires having a prediction of the usage time of the graphic resource for each graphic order.

### SUMMARY OF THE INVENTION

The object of the system according to the invention is to reduce or eliminate the abovementioned disadvantages and to allow a flexible sharing of the graphic resource between several applications of different criticality levels. The core of the system is to add a secure graphic manager to the computing resource.

More precisely, the subject of the invention is a viewing system having a first electronic device called a “computing resource” makes it possible to process at least two graphic applications. The graphic applications have a different criticality level. The criticality levels are established according to the importance of the graphic application in the operation of the system. A second electronic device called a “graphic resource makes it possible to place the graphic applications originating from the first device in video-signal form. A memory is shared between said graphic applications. Each application has a specific storage space in the memory. A set of views comprises display windows. Each application is displayed in at least one window dedicated to the application. The computing resource has a secure graphic manager with a criticality level at least equal to the highest criticality level of the applications and is capable of managing problems of different criticality. The manager has detection means which can determine violations of the segregation of the applications in their respective display window; overrunning of the processing times of each application; and violations of the specific storage spaces.

Advantageously, the means for detecting segregation violation performs the following functions: checks the authorization for each application to display in the various windows; limits the display of each application to its dedicated window. No display originating from the application can be carried out outside the display zone defined by the windows that are associated with it.

Advantageously, if the computing resource has a time period between two successive data refreshes, the means for detecting overrunning of the processing times of each application performs the following functions: allocates to each application a theoretical usage time during each period; measures, for each application and for each time period, the real usage time; computes, for each set of applications, the total real usage times, the total being marked total usage time; compares the total usage time with the length of the period; if the total usage time is greater than the length of the period, determines the faulty applications of which the real usage time overruns the theoretical usage time; sanctions the faulty applications.

Advantageously, the shared memory comprising data called remanent data, the means for detecting violation of the storage spaces performs the following functions: prohibits all the applications from modifying the remanent data; allocates a theoretical storage space to each application; measures the real storage space for each application; compares, for each application, the real storage space with the theoretical storage space; if the real storage space is greater than the theoretical storage space, sanctions the faulty application.

Advantageously, the sanction of the application consists in resetting the system without the faulty application.

Finally, the detection means can be produced, by software, in OpenGL language.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents the general block diagram of a viewing system;

FIG. 2 represents the general block diagram of a secure graphic manager according to the invention.

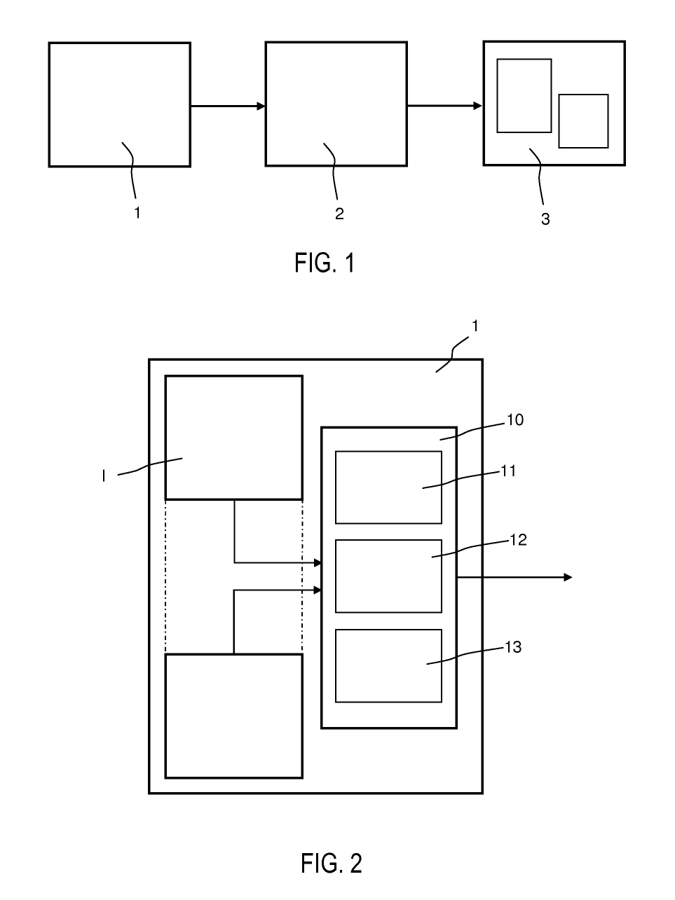

### DETAILED DESCRIPTION OF THE INVENTION

As illustrated in FIG. 2, the core of the invention is to add to the computing resource 1 a secure graphic manager 10, the criticality level of which is at least equal to the criticality level of the most critical application I. As will be seen, this manager performs relatively simple functions, it is therefore easy to provide it with very great reliability. This manager has means making it possible to perform the following detection functions:

violation of the segregation of the applications in their respective display window, the function marked 11 in FIG. 2;

overrunning of the processing times of each application, the function marked 12 in FIG. 2;

violation of the specific storage spaces, the function marked 13 in FIG. 2.

These functions will be explained in detail below. To be easily put in place, the viewing system must have the following features:

all the applications are located on the computing resource;

the computing resource is spatially and temporally segregated. This means that the resource carries out at the same time the secure sharing of its memory space and the secure sharing of its processing time. The various applications have specific storage spaces in the memory and they are computed successively so as not to interfere with one another. As an example, the operating systems produced according to the ARINC 653 standard perfectly satisfy these conditions;

the computing and graphic resources have a criticality level at least equal to the criticality level of the most critical application;

the graphic resource has an interface of the OpenGL type. The OpenGL standard, for OPEN Graphics Library, initially developed by Silicon Graphics, is a specification which defines a multiplatform API, the acronym for Application Programming Interface, for the design of applications generating 2D or 3D images. The interface contains hundreds of different functions which may be used to display complex three-dimensional scenes from simple primitives. This standard is now used very widely and a subset of this standard, called OpenGL ES, ES standing for Embedded System, is standardized by the Khronos Group for use in onboard systems. Khronos Group is a group of manufacturers the mission of whom is to establish standards in a certain number of fields relating to software applications.

An application may be displayed in one or more windows of the viewing screens. Usually, the display rules are as follows:

an application may have several windows;

each application may be displayed in all the windows associated therewith;

a window may be associated with only one application.

The means for detecting violation of the segregation of the applications in their respective display window perform the following functions:

verifying the destination windows of the applications;

limiting the display of each application to their dedicated window.

More precisely, the method for detecting violation of segregation comprises the following steps:

identification by the application of the window in which it wishes to be displayed, that is to say sending its graphic instructions;

checking by the secure graphic manager that this window forms part of those which are associated with said application;

setting status variables of the OpenGL graphic resource at default values. The variables relate, for example, to the color, the line style, its thickness, etc.;

limiting the display of said application to this window by associating a storage space with the application in the graphic resource dedicated to said application. The applications present on the computing resource have in their partition an “API Open GL” application stripped of all the commands making it possible to assign these storage spaces. Only the centralized manager has access to the API OpenGL commands making it possible to access these functions;

generation by the application of the graphic instructions to be sent to the graphic resource;

translation by the graphic resource of the graphic instructions into pixels;

storage of the pixels originating from the application in said storage space;

authorization to display pixels stored in the storage space on the screen by the secure graphic manager. The application data are transferred to the graphic resource and then to the selected viewing window in the position defined by the secure graphic manager.

To allow the display of the application to be limited, the secure graphic manager allocates to each window a storage space in the graphic resource in which it will display the pixels. Usually, the image is of the “bitmap” type or of the “texture” type, that is to say that it comprises a texture. The capabilities inherent in a graphic resource of the “OpenGL—MMU” type make it possible to prevent this space from being violated. MMU is the acronym for “Memory Management Unit”.

When the application must be displayed in several different windows, the above method is reiterated for each display window.

In a viewing system, the viewing screens are refreshed at a certain rate. Usually, the time T separating two refreshes lies between 10 milliseconds and 100 milliseconds. The graphic manager has means for detecting overruns of the processing times of each application. They perform the following functions:

allocation to each application I of a theoretical time T_{I} for access to the graphic resource during each period;

measurement for each application I and for each time period of the real access time t_{I}. To measure this real time of usage t_{I}, the manager initiates a time measurement as soon as it gives the application I access to the graphic resource. Between each application I, the graphic manager sends a synchronization command to the graphic resource, also called an appointment. This command makes it possible to ensure that all of the graphic commands have indeed been executed by the graphic resource. If the appointment is not made before the end of the imparted time T_{I}, the application has overrun the time allocated to it and is identified as such after the fact by the graphic manager;

computation, for all of the applications, of the total S_{I} of the real usage times, the total being marked total usage time;

comparison of the total usage time S_{I} with the duration of the period T;

if the total usage time is longer than the duration of the period, determination of the faulty applications the real usage time of which overruns the theoretical usage time;

sanctioning of the faulty applications. The sanction of the faulty application may be, for example, the immediate stopping of the faulty application.

The graphic manager performs a third security function. It checks that an application cannot disrupt the memory zones of the graphic resource of another application. These memory zones are:

on the one hand storage spaces for the pixels defined above. As indicated, the inherent capabilities of an “OpenGL—MMU” graphic resource are used.

on the other hand, the remanent memory zones storing the various information items of the images of the “bitmap”, “texture”, “display lists” type and any other data not being updated on each cycle.

For this purpose, the graphic manager has means for detecting violation of the storage spaces which perform the following functions:

allocation to each application of a theoretical storage space;

identification by each application to the secure graphic manager of the remanent memory zones which it needs and which it owns;

prohibiting all the applications from modifying the remanent data directly. The remanent data modification requests are sent by the application to the secure graphic manager. The latter checks that the application has the right to modify these data and that it is the owner thereof. If such is the case, it authorizes the modification;

measurement for each application of the storage space actually used;

comparison, for each application, of the real storage space with the theoretical storage space;

if the real storage space is greater than the theoretical storage space or if an application attempts to modify a remanent memory zone of which it is not the owner, sanctioning the faulty application, the sanctioning of the application may, for example, consist in resetting the system without the faulty application.

The secure graphic manager comprises many advantages:

by multiplication of the checks in very different fields such as the management of space, time and memory resource, it makes it possible to achieve a very high level of security of the graphic applications.

It does not require a detailed knowledge of the graphic architecture used. It is therefore possible to introduce any type of graphic processor without detailed knowledge of its architecture or of its operation.

The measurements of resource use are carried out after the fact without making assumptions.

It has very great flexibility making it possible to keep the system operating so long as the graphic resource is not congested.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A viewing system comprising:
a first electronic device for processing at least two graphic applications, said graphic applications having a different criticality level, the criticality levels being established according to the importance of the graphic application in the operation of the system;
a second electronic device making it possible to place the graphic applications originating from the first device in video-signal form;
a memory shared between said graphic applications, each application having a specific storage space in said memory;
a set of views comprising display windows, each application being displayed in at least one window dedicated to said application;
wherein the computing resource comprises a secure graphic manager with a criticality level at least equal to the highest criticality level of the applications and capable of managing problems of different criticality, said manager having the following detection means:
violation of the segregation of the applications in their respective display window;
overrunning of the processing times of each application;
violation of the specific storage spaces.

2. The viewing system as claimed in claim 1, wherein the means for detecting segregation violation performs the following functions:
checks the authorization for each application to display in the various windows;
limits the display of each application to its dedicated window.

3. The viewing system as claimed in claim 1, wherein, if the computing resource has a time period (T) between two successive data refreshes, the means for detecting overrunning of the processing times of each application performs the following functions:
allocates to each application a theoretical usage time (T_{I}) during each period;
measures, for each application and for each time period, the real usage time (t_{I});
computes, for each set of applications, the total real usage times, the total being marked total usage time (S_{I});
compares the total usage time with the length of the period;
if the total usage time is greater than the length of the period, determines the faulty applications of which the real usage time overruns the theoretical usage time;
sanctions the faulty applications, the sanction being resetting the system without the faulty application.

4. The viewing system as claimed in claim 1, wherein, the shared memory comprises remanent data, the means for detecting violation of the storage spaces performs the following functions:
prohibits all the applications from modifying the remanent data;
allocates a theoretical storage space to each application;
measures the real storage space for each application;
compares, for each application, the real storage space with the theoretical storage space;
if the real storage space is greater than the theoretical storage space, sanctions the faulty application.

5. The viewing system as claimed in claim 1, wherein the detection means are produced, by software, in OpenGL language.

6. The viewing system as claimed in claim 2, wherein the detection means are produced, by software, in OpenGL language.

7. The viewing system as claimed in claim 3, wherein the detection means are produced, by software, in OpenGL language.

8. The viewing system as claimed in claim 4, wherein the detection means are produced, by software, in OpenGL language.
